(19) United States
(12) Patent Application Publication
(10) Pub. No.: US 2014/0195904 A1
(43) Pub. Date: Jul. 10, 2014

(54) TECHNICAL DOCUMENTS CAPTURING AND PATENTS ANALYSIS SYSTEM AND METHOD

(71) Applicants: Chao-Chin Chang, Taipei City (TW); Iou-Ming Lou, Taipei City (TW)

(72) Inventors: Chao-Chin Chang, Taipei City (TW); Iou-Ming Lou, Taipei City (TW)

(21) Appl. No.: 14/060,617

(22) Filed: Oct. 23, 2013

Related U.S. Application Data
(63) Continuation-in-part of application No. 13/734,999, filed on Jan. 6, 2013, now Pat. No. 8,599,449.

(51) Int. Cl. G06F 17/21

(52) U.S. Cl. CPC G06F 17/212
USPC 715/273

(57) ABSTRACT

A system and related method are provided for managing technical documents. The system includes a graphical screen divided into a plurality of document units arranged in a m×n manner, where both m and n are integers larger than 1. Each of the document units occupies a screen area for displaying document information of a document, and said document information including important information, at least one related drawing or both of the document.

### CROSS-REFERENCES TO RELATED APPLICATIONS

This application is a continuation-in-part of U.S. Ser. No. 13/734,999, which is a continuation of U.S. Ser. No. 12/346,775, now U.S. Pat. No. 8,373,880. Both are incorporated herein by reference. The U.S. patent application Ser. No. 13/734,999 is a continuing application of U.S. patent application Ser. No. 12/346,775, filed on Dec. 30, 2008, which is incorporated herewith by reference.

### FIELD OF THE INVENTION

The present invention generally relates to a system and method for capturing technical documents and commentating captured documents thereof.

### BACKGROUND OF THE INVENTION

U.S. Pat. No. 6,058,417 disclosed a method and apparatus for information presentation and management in an online trading environment where the images can be harvested from a plurality of sites based upon user-supplied information, including descriptions of items for sale and locations from which images that are to be associated with the items can be retrieved. Then, thumbnail images are created corresponding to the harvested images and aggregated onto a web page for presentation at a remote site. Similarly, upon a query from a user, thumbnail images corresponding to items that satisfy the user query are displayed, each of the thumbnail images previously having been created based upon a user-specified image. While the above patent disclosed an interface with arranged thumbnail images for online trading environment, the above patent does not disclose the application of the disclosed technique to the technical document analysis and to the reading management interface. Hence, the above patent does not disclose the technique of capturing the diagrams or images contained in technical documents.

U.S. Pat. No. 5,963,966 disclosed an automated capture of technical documents for electronic review and distribution, by using OCR to dissect the technical documents into drawing files and text files, and filing to appropriate locations for storage or display. However, the use of OCR to scan the entire technical document will consume a large amount of system resource and has a low yield rate.

The research and development team usually performs a lot of documents searching and reading in the initial stage of technical development. For example, Taiwan Patent Publication No. 200417882 disclosed a method for generating patent analysis data, by looking up in an external database to capture a plurality of patents or classification numbers, and then performing patent analysis and relevance linkage according to the patents, classification numbers, and feature information.

FIG. 1 shows an exemplary flowchart of Taiwan Patent No. 567432 of a system and method for mining and statistical analyzing patent information. As shown in FIG. 1, the user selects analysis type and sets the analysis conditions via a client interface. The analysis conditions are translated by an application software server into inquiry conditions of specific format. The inquiry conditions are used to search the database, and the search result is transmitted by the application software server to the client computer to display the analysis result.

In the patent information analysis, usually as shown in FIG. 2, the list mode is used to display the related information of the technical documents, such as document, title, document number, application date, publication date, published date, issue date of patent, author/inventor, assignee, and so on. If a reader wants to obtain further information, the reader must enter the subject to read the abstract or even entire document of text and drawings to know whether the document is of interest and relevance. This takes much time and more system resource for data reading and processing, thus becomes a major performance bottleneck for the research team.

Therefore, it remains an important issue as to how to save system resource and effectively integrate the documents in a plurality of technical databases and effectively analyze the contents and the trends of technical documents.

The aforementioned techniques only disclose the capturing of the data from the external database to the local database or server for analysis, but neither disclose the use of the relevance operation of documents of the external database nor provide the reader with an image of fast information digestion or required interactive commentating platform to share comments and reviews to improve the technical data reading efficiency.

### SUMMARY OF THE INVENTION

The exemplary disclosed embodiments according to the present invention may provide a management system and method on technical documents, which may perform classification, capturing, reading, commenting and sharing information, and exchanging comments. The disclosed embodiments shift related drawings from a group of technical documents through preprocessing, and integrate the captured important information onto a screen, so that the readers may review the documents and information through a graphic screen, instead of repeatedly operating resource-consuming Graphic Format Files, such as PDF or TIFF. The disclosed embodiments may further allow the readers to process technical classification, management and export/import for the group of technical documents. Readers may comment on an information sharing platform after reviewing the technical documents.

In an exemplary embodiment, the disclosed is directed to a system for capturing technical documents. The capturing system comprises: a verify shift unit, a capture and select module, and a data capturing module. The verify shift unit uses the relation of technical documents as a judge basis to configure the capturing parameters of the technical documents. The capture and select module captures the related information from technical documents through the capturing parameters configured by the verify shift unit. The data capturing module selects important information, and displays the important information together with the related information captured by the capture and select module onto a screen for the readers.

In another exemplary embodiment, the disclosed is directed to a system for reading technical documents. The reading system at least comprises: a graphical screen, a classification module, a management module, and an import/export module. Through the graphical screen, the classification module allows readers to classify a group of graphical technical documents into different technical classes or product classes and store in a system. The management module allows readers to file, after finishing identifying the technical data, into the system according to features of the technical data, or delete the selected technical data from the system. The import/export module allows readers to import and export the selected technical data from or to the system.

The reading system may further include a hyperlink module to link with the databases in the system, and obtains the corresponding documents/materials in the databases.

In another exemplary embodiment, the disclosed is directed to a system for commenting technical documents. The commentating system at least comprises: a comment subject unit, a reading comment unit and an attachment unit. The comment subject unit allows readers to input the comment subject as well as display different comment subjects in the system. The reading comment unit allows the readers to log the comments after reading as well as displaying comments from other readers. The attachment unit allows the readers to attach the data collected or generated by the readers during reading and analysis.

In another exemplary embodiment, the disclosed is directed to a method for capturing technical documents. The capturing method comprises: using the relation of technical documents as a judge basis to configure the capturing parameters of the technical document; selecting the related information from the technical documents according to the configured capturing parameters; and capturing the selected related information and displaying the relevant information and the selected related information on a screen.

In another exemplary embodiment, the disclosed is directed to a method for reading technical documents. The reading method comprises: capturing important information and relevance information of a group of technical documents and providing a screen to display the important information and related information for the readers to read; and performing functions of technical document classification, filing, deleting and importing/exporting or any combination of the above functions through the screen.

In another exemplary embodiment, the disclosed is directed to a method for reading and commentating technical documents. The reading and commentating method comprises: the aforementioned exemplary reading method, in which a step of providing an information sharing platform is further included. The information sharing platform allows the readers to log the comments after reading technical documents as well as to attach the data generated or collected during the reading and analysis process, or even to display comments from other readers.

In the aforementioned exemplary embodiments, the capturing system and the reading system for technical documents may integrate as a capturing and reading system for technical documents. The reading system and the commentating system for technical documents may also integrate as a reading and commentating system for technical documents. Or, the capturing system, the reading system and the commentating system for technical documents may integrate as a capturing, reading and commentating system for technical documents.

When applied to the analysis for design patents, the present invention may depict powerful results. For example, by displaying main figures from a plurality of patent documents of a group, the present invention enables the user to accelerate the patent map shifting at the initial search stage so as to reduce the user's demands on resource-consuming graphic format files and improve the system resource utilization.

The foregoing and other features, aspects and advantages of the present invention will become better understood from a careful reading of a detailed description provided herein below with appropriate reference to the accompanying drawings.

### BRIEF DESCRIPTION OF THE DRAWINGS

FIG. 1 is an exemplary flowchart illustrating the operation of a method for generating patent analysis data.

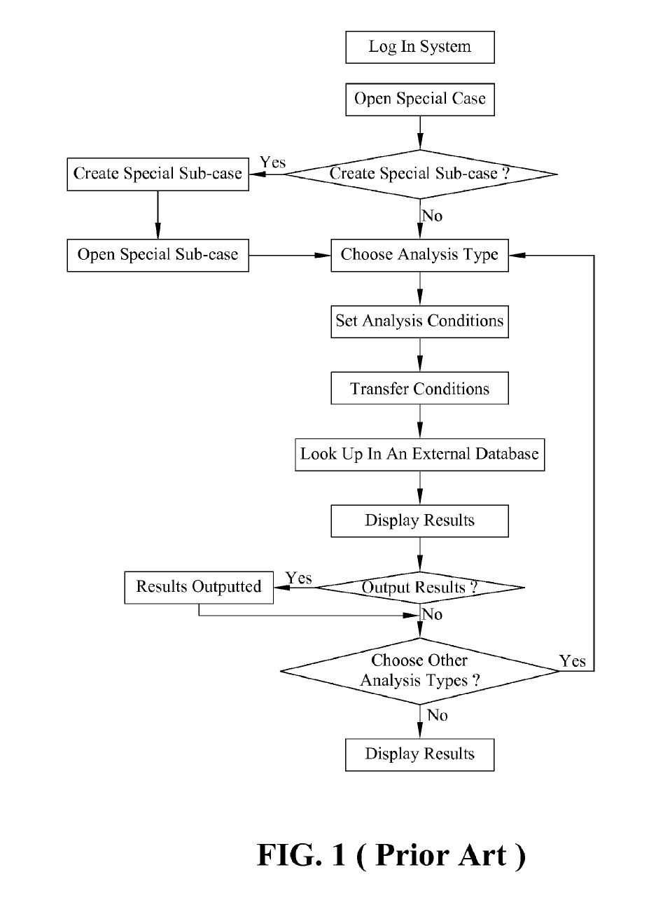

FIG. 2 shows a list mode being used to display the related information of the technical documents in a conventional patent document analysis exemplar.

FIG. 3A is an exemplary capturing system for technical documents, consistent with certain disclosed embodiments of the present invention.

FIG. 3B is an exemplary graphic screen, consistent with certain disclosed embodiments of the present invention.

FIG. 4A is an exemplary diagram, illustrating selecting modules included in a verify shift unit, consistent with certain disclosed embodiments of the present invention.

FIG. 4B is an exemplary diagram, illustrating capturing parameters by taking a technical document as an example, consistent with certain disclosed embodiments of the present invention.

FIG. 5 is an exemplary reading system for technical documents, consistent with certain disclosed embodiments of the present invention.

FIG. 6 is an exemplary diagram, illustrating classification of technical data through a classification module, consistent with certain disclosed embodiments of the present invention.

FIG. 7 is an exemplary diagram, illustrating filing the technical data into two databases in a system, consistent with certain disclosed embodiments of the present invention.

FIG. 8 is an exemplary commentating system for technical documents, consistent with certain disclosed embodiments of the present invention.

FIG. 9 is an exemplary implementation for each unit in the commentating system for technical documents, consistent with certain disclosed embodiments of the present invention.

FIG. 10 is an exemplary capturing and reading system for technical documents, consistent with certain disclosed embodiments of the present invention.

FIG. 11 is an exemplary reading and commentating system for technical documents, consistent with certain disclosed embodiments of the present invention.

FIG. 12 is an exemplary capturing, reading and commentating system for technical documents, consistent with certain disclosed embodiments of the present invention.

FIG. 13 is an exemplary flowchart illustrating a capturing method for technical documents, consistent with certain disclosed embodiments of the present invention.

FIG. 14 is an exemplary flowchart illustrating a reading method for technical documents, consistent with certain disclosed embodiments of the present invention.

FIG. 15 is an exemplary flowchart illustrating a reading and commenting method for technical documents, consistent with certain disclosed embodiments of the present invention.

FIG. 16 is another embodiment of the present invention.

FIG. 17 A to FIG. 17D illustrate document units appeared in different display ratios.

FIG. 18 illustrates a drag-n-drop operation.

FIG. 19 illustrates an interface example for commenting a patent document.

FIG. 20 illustrates a tracking list during analysis of multiple patent documents.

FIG. 21 illustrates a drawing generated under OCR processing.

### DETAILED DESCRIPTION OF THE PREFERRED EMBODIMENTS

The exemplary disclosed embodiments of the present invention may utilize a plurality of databases, such as databases for technical documents, analyze a group of original technical documents, and reorganize as a data group with relation correspondence to establish the internal databases. After the relation information of the group of technical documents, such as patent documents or research papers, is captured, the disclosed embodiments may provide the captured related information to the readers with a graphical screen for reading the technical documents as well as other processing tasks, such as, classifying, filing, deleting, importing/exporting, and so on. In addition, the disclosed embodiments may allow the user to record the comments after viewing the technical documents or shows the comments from other readers. The disclosed embodiments may also attach or generate other data collected or generated during the reading and analysis. Therefore, the user at the client end may analyze the contents and the trend of the technical documents effectively and rapidly under minimized system resource.

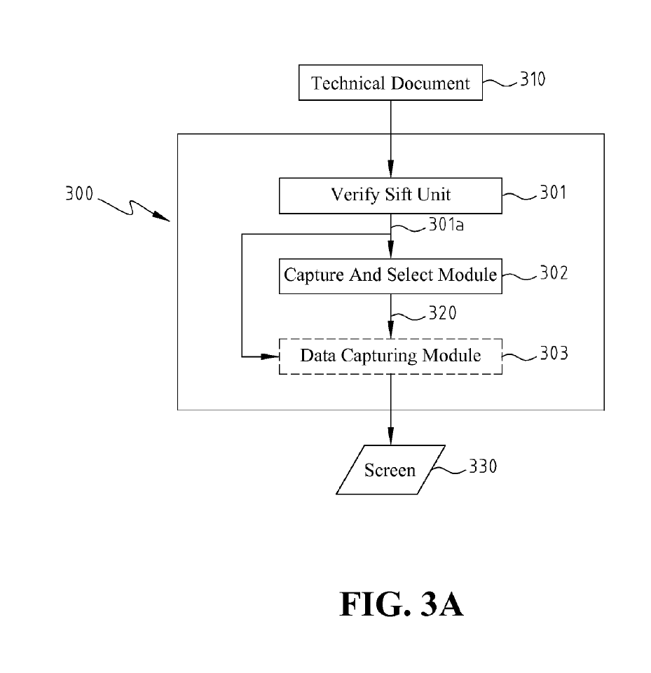

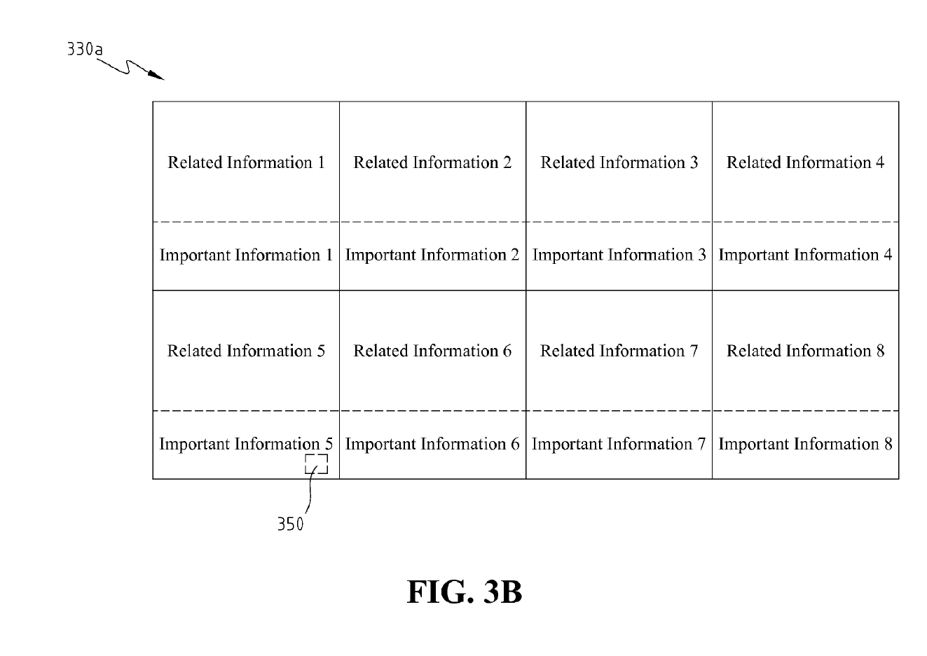

FIG. 3A shows an exemplary capturing system for technical documents, consistent with certain disclosed embodiments of the present invention. As shown in FIG. 3A, a capturing system 300 captures related information 320 from a technical document 310, such as patent document or research paper. Captured related information 320 may include image or text. Capturing system 300 may provide a graphical screen, usually arranged as lists or tables for the reader to read the related information. Relation information 320 is the result generated by performing at least a relation operation and analysis on at least an internal database or technical document.

Relation refers to the correspondent relationship among technical documents or data in the database, including text and drawings. For example, relation may be the correspondent relationship between the application number and the application date, or the correspondent relationship between the journal title and the inventor.

Relation operation refers to the operations, comparison or shifting, such as Boolean logic, weighting, etc., on the technical document or data in the database. Taking patent documents as an example, the shifting on the data with high relation operation may include the selection of patent number, application date, inventor, assignee information of the same patent. The shifting on the data with low relation operation may include the selection of inventor information based on the patent number or inventor information of other patent numbers.

In the exemplary capturing system 300 of FIG. 3A, the capturing system 300 comprises a verify shift unit 301, and a capture and select module 302. Verify shift unit 301 uses the relation information of technical document 310 as a judge basis to configure the capturing parameters of technical document 310. Capture and select module 302 captures the related information 320 from technical document 310 through capturing parameters 301a configured by verify shift unit 301. Each related drawing is the main figure of a technical document, such as the first-page figure or the characteristic figure of the technical document. The term ‘relation information’ in this example may refer to information that is extracted, calculated, converted, and/or derived from one or more than one fields or parts of a technical document for processing the technical document. The term ‘related information’ in this example may refer to fields or any part of a technical document that indicates an attribute, a parameter, a status or other information of the technical document. For example, relation information may refer to a estimated starting location of a drawing shown in a front page of a patent image file, while ‘related information’ like patent number, assignee information, etc. that are fields of a patent document may be used for helping determine the starting location. In this patent document example, the related information is used to obtain the relation information, and the relation information is further used to obtain a related drawing, which is also a type of related information of a patent document.

Capturing system 300 may further include a data capturing module 303 to select important information, such as title of the patent document, assignee, inventor, document number or specific labels, and provide a screen 330 together with relation information 320 captured by capture and select module 302 to the readers. FIG. 3B shows an exemplary screen 330a of screen 330.

Screen 330a shows 8 pieces of related information and their corresponding important information. If the 8 pieces of related information are the main figures in the first page of 8 U.S. patents, their corresponding important information may be the patent title and/or the U.S. patent number and/or assignee. Graphical screen 330a may also arrange the related information and corresponding important information in a regular manner, such as a table or list, or in a continuous webpage form so that the reader may scroll up and down to read, or even alternatively, in a discontinuous webpage form so that the reader may read page by page. The graphical screen (or at least one document unit) may also provide hyperlinks, may be shown as mark 350 or the whole region of the document unit, to link the system database for obtaining advanced related information, such as full text of the patent. Furthermore, when the cursor hovers to the related information, a popup window will display the abstract, title, author (inventor), owner (assignee), publication (issue) date or its any combination of the technical document corresponding to the related information.

The related information and/or corresponding important information of any block may be defined as a document unit. The related information contained in the document unit may be the main figures in the first page or the characteristic figure of a patent, and the corresponding important information may be title, document (patent) number, author (inventor), owner (assignee), application serial number, date (of filing, publication, or issue), abstract, and/or any combination of the above. The document units are arranged in a m×n manner, where both m and n are integers greater than 1. The preferred embodiment of m is 3-7, while the preferred embodiment of n is 3-1000. For better visual sensation, the preferred value of n is between 8 and 30.

For example, for a web page to display 100 patent documents, the layout of the web page may be 4×25 document units, 5×20 document units, or any other regular arrangements. If the number of patent documents cannot be arranged as m×n, for example, 97, the arrangement of 5×20 format will leave three vacancies. However, this is still within the scope of m×n format. The corresponding important information may be located near the related information, for example, on top of, beneath, to the right of or to the left of the related information. Alternatively, a part of the corresponding important information can be displayed in a popup window when the cursor hovers over the related information. For example, in FIG. 3B, the corresponding important information displays the title, issue number and issue date. When the cursor hovers over the related information, the popup window displays the title, abstract, date (of priority, filing, publication, or issue), patent family/families, author (inventor), assignee or any combination of the above.

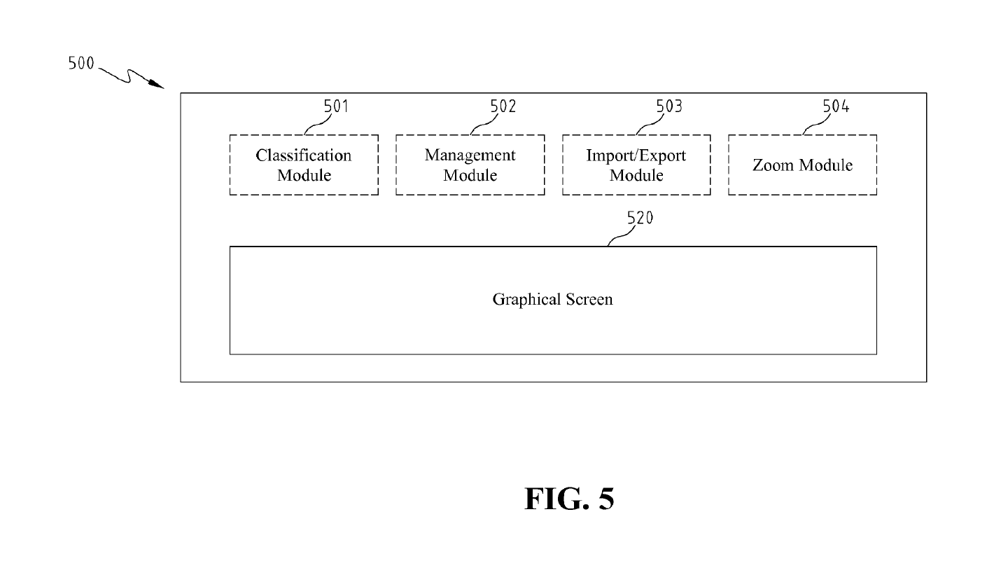

It is also worth noting that the zoom in/zoom out operation may be performed on the document unit. There may be three ways to implement the zoom in/zoom out operation of document unit. The first approach is when the cursor hovers over the document unit, a larger image of the document unit may be displayed. The second approach is that the system will determine the display ratio of the images of the document units according to the values of m and/or n. The third approach is to use a zoom module to adjust the display size of the images of the document units (see FIG. 5 for details).

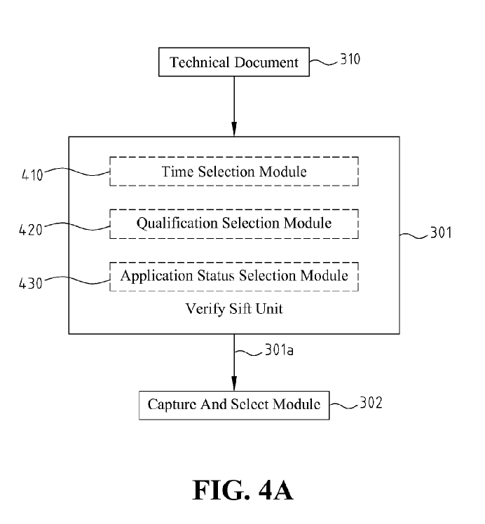

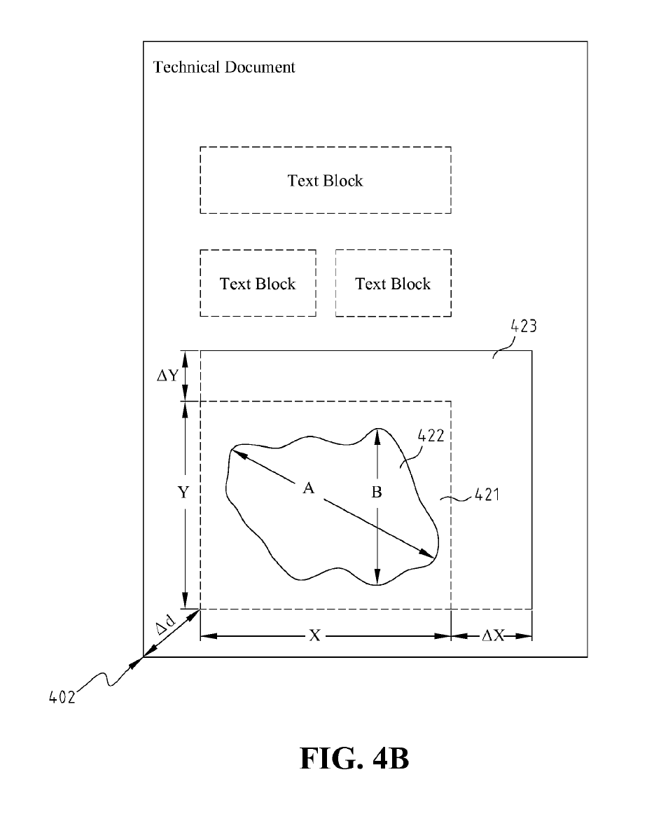

If the technical document 310 is a patent document, capturing system 300 may use time in the patent, application status, qualification or contents in the patent as the judge basis to perform capturing and analysis of the patent information. In this manner, verify shift unit 301 may be a type of deterministic logic for using the qualification, application status, time, and contents of the patent document as the judge basis to perform the configuration of capturing parameters of the patent document. Then, verify shift unit 301, as shown in FIG. 4A, may further include a time selection module 410, a qualification selection module 420, an application status selection module 430 or any combination of the above modules. FIG. 4A is an exemplary diagram illustrating selecting modules included in verify shift unit 301, consistent with certain disclosed embodiments of the present invention.

When the technical document 310 is a patent document, for example, time selection module 410 of verify shift unit 301 in FIG. 4A may use the related time information, such as application date, publication date, issue date, or priority date of the patent document, as the judge basis to perform the configuration of the capturing parameters of technical documents according to different times. For example, the configured capturing parameters may be the starting capturing point, capturing range and related offset of technical document 310. FIG. 4B is an exemplary diagram, illustrating capturing parameters by taking a technical document as an example, consistent with certain disclosed embodiments of the present invention.

Referring to FIG. 4B, starting capturing point and capturing range may be default value, such as the intersection of two boundaries of the original image of the technical document, marked as 402, or the geometric center of the document as the starting capturing point or axis origin (0,0). The capturing range may be defaulted to be a rectangle 421 with length of X and width of Y, or any geometrical area 421 formed with A as a long axis and B as the short axis.

Referring to FIG. 4B, the technical document, for example, is a patent document. If the application date of the patent document is used as the judge basis, the intersection of two boundaries of the original image of the technical document as the origin, and the default capturing range is a 330×400 (pixels) rectangle. When the application date is year 2006, for example, the starting capturing point may be set as related offset Δd (+10 mil) from coordinate origin 402, and the capturing range, for example, may be ΔX=10 pixels along the X-axis and ΔY=20 pixels along the Y-axis. In other words, the capturing range is adjusted by the rectangle 423 with length X+ΔX and width Y+ΔY. If only a certain application date is used as a judge basis, the starting capturing point, for example, is the +5 mil from the intersection of the two boundaries of the original image of the patent document, and the capturing range is the rectangle of 310×420, where ΔX and ΔY may be either positive or negative, and 1 mil is 1/1000 inch.

Similarly, qualification selection module 420 may be a qualification verification module for patent documents. In other words, qualification selection module 420 may use the information in the patent document related to the personnel, country, classification or qualification, such as inventor, assignee, agent, IPC, USC, ELCA, FI/F-term, examiners, etc., as the judge basis to configure the capturing parameters of the patent documents, such as aforementioned starting capturing point, capturing range and related offset. For the example of using the assignee as the judge basis, if the assignee is Industrial Technology Research Institute (ITRI) of Taiwan, the related offset Δd of the configured capturing range may be coordinate origin+20 mil, ΔX of capturing range may be +50 pixels and ΔY of capturing range may be +60 pixels, where ΔX and ΔY may be either positive or negative.

Similarly, the application status selection module 430 may use the application status (such as, publication, notice of allowance, divisional or continuation) or refer to information disclosure statement (IDS), number of families, word count of abstract, or application country as the judge basis to configure the capturing parameters of the patent document.

After the capturing parameters are configured by date selection module 410, qualification selection module, application state module 430 or any combination of the above modules, a weighing or Boolean operation, such as AND or OR, may be performed on the capturing parameters of each selection module to finalize the configuration of the capturing parameters. Use the aforementioned application date of year 2006 and ITRI of Taiwan as assignee as an example. The sum of the capturing related offset is equal to the capturing related offset of application date (i.e. 2006) multiplied by weight W1 (of application date) and the capturing related offset of assignee (i.e. ITRI) multiplied by weight W2 (of assignee), where W1+W2=100%. When W1=W2=50%, the sum of the related offset Δd is 15 mil.

Similarly, weight W3 for the capturing range of application date=2006 and weight W4 for the capturing range of assignee=ITRI of Taiwan may be obtained. When W3=40% and W4=60%, the sum of ΔX of the capturing range is 34 and the sum of ΔY of the capturing range is 28. Therefore, for patent documents applied by ITRI of Taiwan in 2006, the starting capturing point is +15 mil from the intersection of two boundaries of the original image of the patent document and the capturing range is the rectangle of 334×328 pixels. The starting capturing point and the capturing range of the patent document may be obtained accordingly.

According to the present invention, the reader may then perform classification, filing, deleting, importing/exporting by reading the graphical screen or through hyperlink module 350. FIG. 5 is an exemplary reading system for technical documents, consistent with certain disclosed embodiments of the present invention.

Referring to the exemplary embodiment of FIG. 5, technical document reading system 500 may comprise a graphical screen 520 with m×n document units, and m and n are positive integers. In general, both m and n are greater than 1. It may further include a classification module 501, a management module 502, an import/export module 503, a zoom module 504, or any combination of the above modules. Graphical screen 520 may be captured by capturing system 300. Through graphical screen 520, the reader may use classification module 501 to classify a group of graphical technical documents into different technical classes or product classes and stores in a system. Through management module 502, the readers may file, after finishing the judgment of the technical data, into the system according to features of the technical data or delete the selected technical data from the system. Import/export module 503 is for importing and exporting the selected technical data from or to the system. Zoom module 504 is for zooming in/zoom out the document units so that different sizes of images of document units can be displayed. In reading system 500, there are many ways to realize each module.

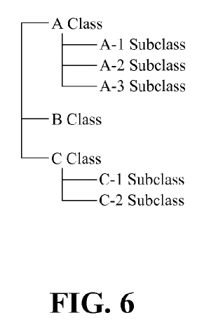

In reading system 500, the reader may accomplish the classification of technical data based on the sub-class to which the feature of the technical data belongs. FIG. 6 is an exemplary diagram, illustrating classification of technical data through classification module 501, consistent with certain disclosed embodiments of the present invention. In the example of FIG. 6, the technical data is classified into A, B and C classes, and may further refine the classification if necessary. For example, A class is further divided into A-1, A-2 and A-3 subclasses, and C class is divided into C-1 and C-2 subclasses.

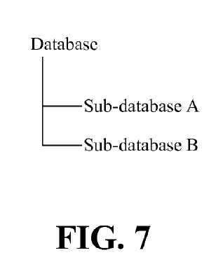

After the reader finishes the judgment of the technical data, the reader may use management module 502 to file the technical data to the sub-database of the system according to the feature of the technical data. FIG. 7 shows the technical data being filed into two sub-databases A and B, consistent with certain disclosed embodiments of the present invention.

According to the present invention, the reader may log the comments to the technical documents or read comments of other readers. Accordingly, another exemplary embodiment of the present invention provides a commentating system for technical documents. The commentating system is an information sharing platform for review reports. The commentating system may provide the reader with the capability to log the comments on the technical documents after reading, show comments from other readers and attach or generate data collected or generated in reading and analyzing the technical document, such as the file wrapper of the patent document, news event, trading information, lawsuit information and so on.

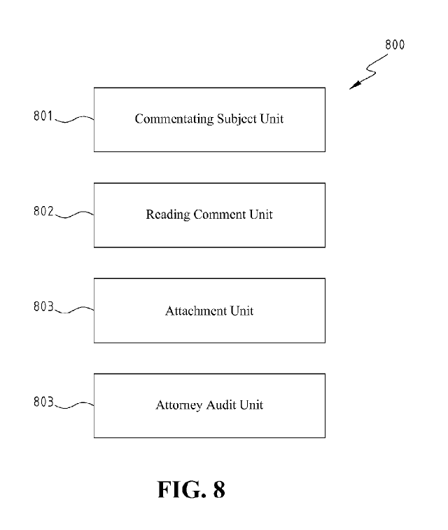

FIG. 8 shows an exemplary commentating system for technical documents, consistent with certain disclosed embodiments of the present invention. The commentating system 800 at least comprises a commentating subject unit 801, a reading comment unit 802, an attachment unit 803 and/or an attorney audit unit 804. Commentating subject unit 801 may allow the reader to input the comment subject as well as display different commentating subjects in the system. Reading comment unit 802 may allow the reader to log the comments after reading as well as display comments from other readers. Attachment unit 803 may allow the reader to attach the data collected or generated by the reader during reading and analysis. Attorney audit unit 804 provides an interface for the attorney to perform the tasks of commenting with commentating subject unit 801 and reading comment unit 802 so that the analysis table or data can be used in seeking legal opinion or taking legal action. The interface is configured to allow authorized or attorney to login with specific account to check on the data or the comments and to perform confirmation, communication or interaction so that the related comments are protected under the attorney-client privilege.

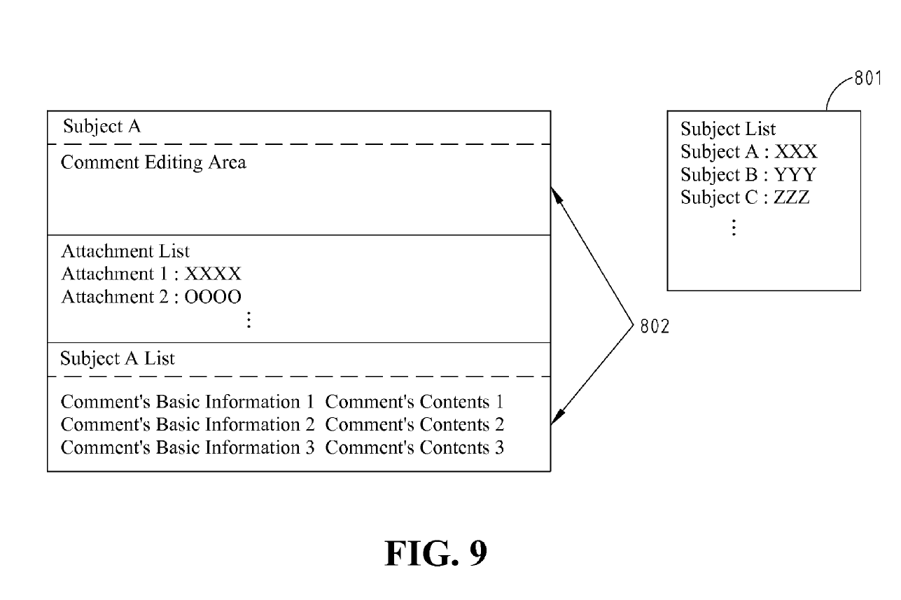

The units of the commentating system may be realized in many ways. For example, in the exemplary embodiment of FIG. 9, commentating system 800 may generate date, reader's name or identity for a subject A automatically on reading comment unit 802. The reader may log the comments in the comment editing area after reading the technical document, such as summary, critics, and reviews of the technical document. Comments from other readers may also be displayed on reading comment unit 802. For example, for subject A, three comments from other readers are listed. Each comment may include the basic information and the contents of the comment, and may be displayed in the manner of a blog. The reader may input the subject to comment subject unit 801 as well as list different subjects, such as A, B, C, etc. In reading and analysis, the reader may collect or generate other data, and these data may be generated as an attachment file or through hyperlink, and attached in attachment unit 803. For example, in the attachment list, attachment 1 is a file wrapper of the patent document and attachment 2 is the news event or the trading information, etc.

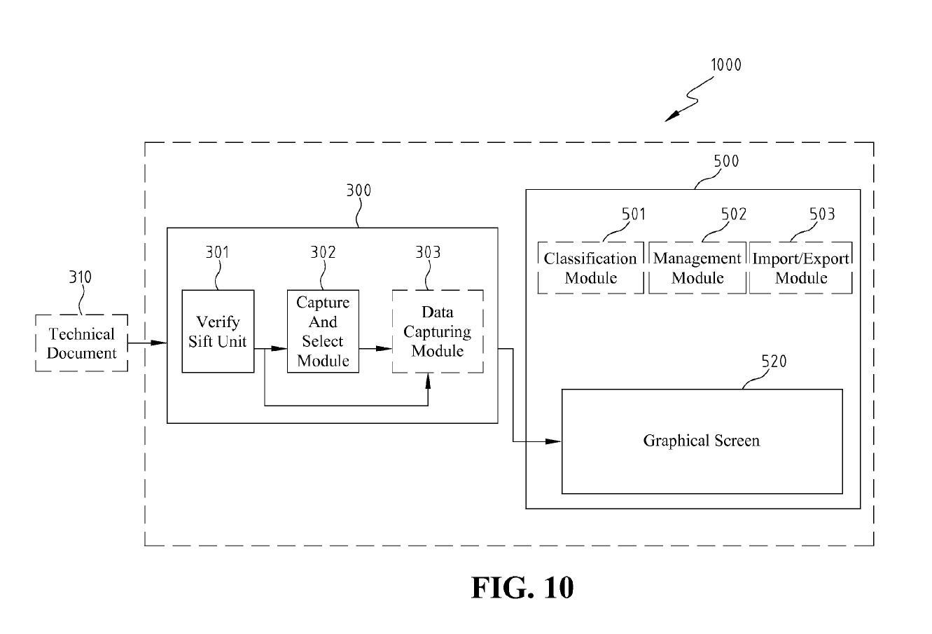

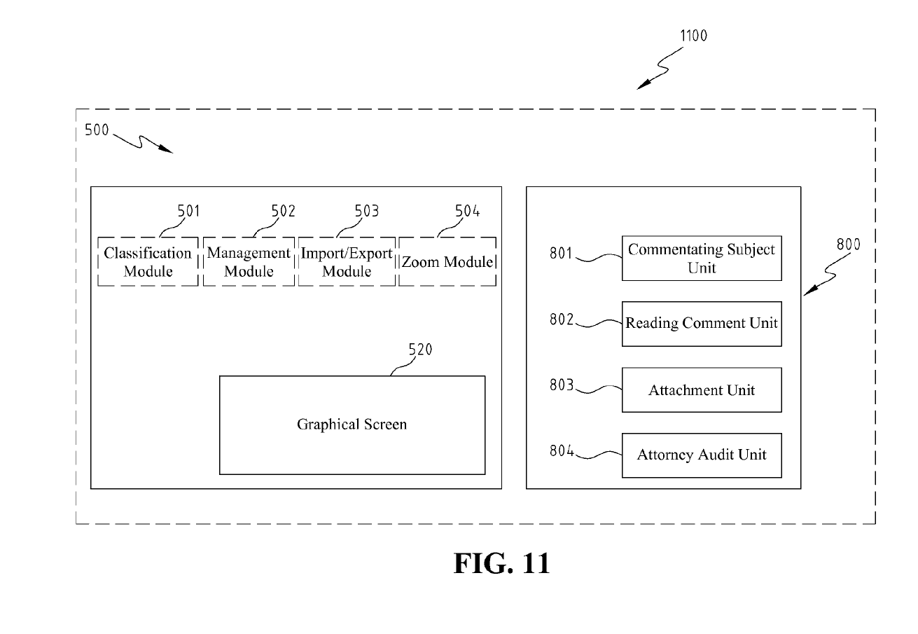

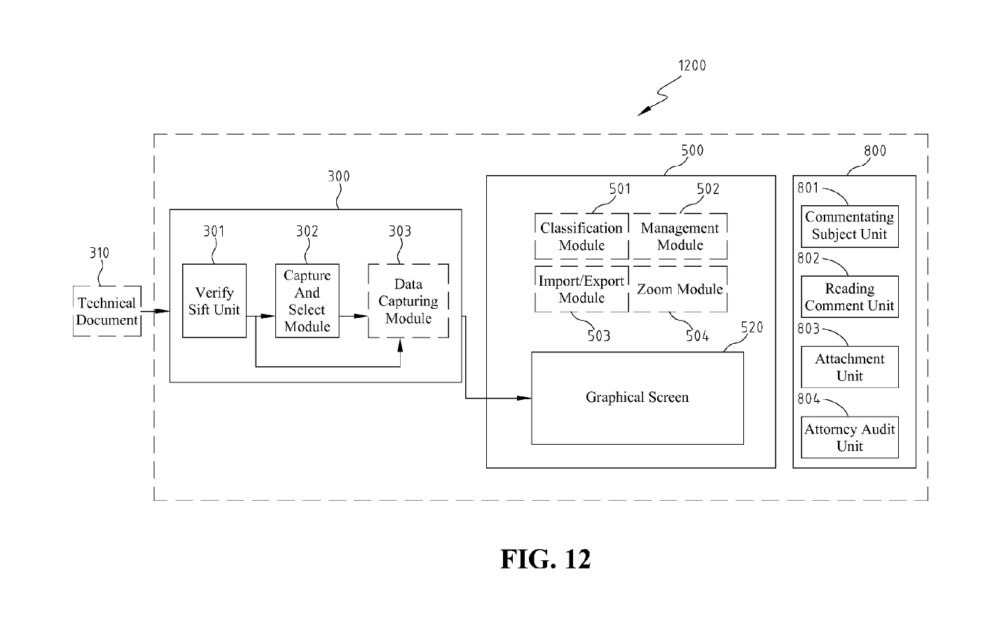

According to the present invention, technical document capturing system 300 and reading system 500 may be integrated into a capturing and reading system 1000 for technical documents, as shown in FIG. 10. Similarly, reading system 500 and commentating system 800 for technical documents may also be integrated into a reading and commentating system 1100 for technical documents, as shown in FIG. 11. In some specific embodiment, reading and commentating system 1100 may include two commentating systems 800, where one commentating system 800 is for all the system users to share all the information, and the other commentating system 800 is for authority control to allow only specific users to share specific information. Capturing system 300, reading system 500 and commentating system 800 for technical documents may all be integrated into a capturing, reading and commentating system for technical document 1200, as shown in FIG. 12. Each system may be integrated according to the actual application.

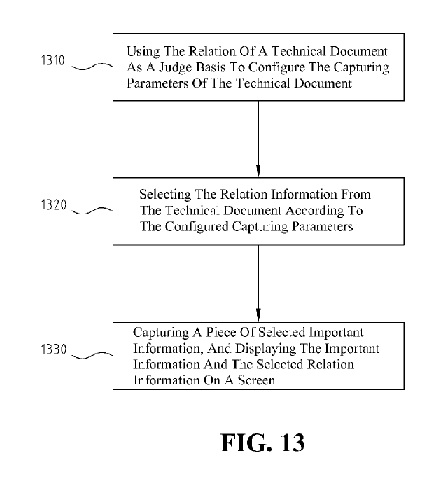

Following FIG. 3A and the above description, the present invention may also disclose a capturing method for technical document, as shown in the exemplary flowchart of FIG. 13. Referring to FIG. 13, the relation of a technical document is used as a judge basis to configure the capturing parameters of the technical document, as shown in step 1310. The relation information is selected from the technical document according to the configured capturing parameters, as shown in step 1320. A piece of selected important information is captured, and the important information and the selected related information are displayed on a screen, as shown in step 1330.

As mentioned above, the configured capturing parameters at least include the starting capturing point, capturing range and related offset of the technical document. The screen may also provide hyperlink to link the system database for obtaining advanced related information or full document/text of the technical document (or patent).

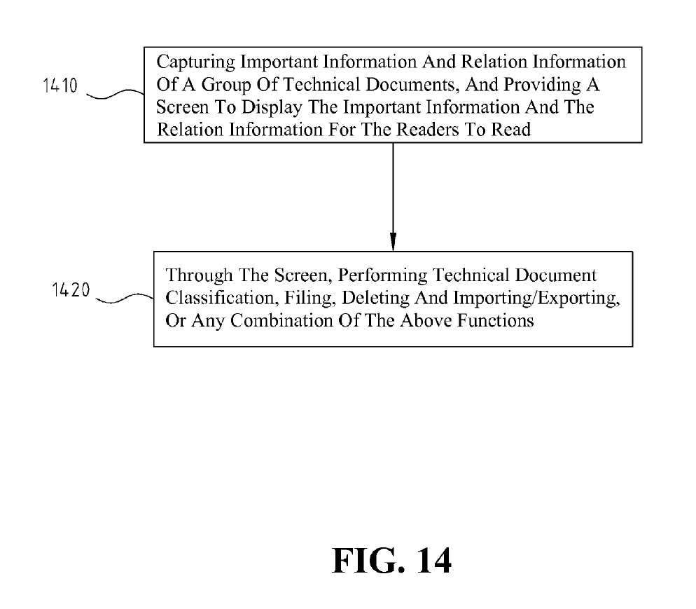

Following FIG. 5 and the above description, the present invention may also disclose a technical document reading method, as shown in FIG. 14. In step 1410, important information and related information of a group of technical documents are captured, and a screen is provided to display the important information and the related information for the readers to read. Through the screen, the reader may perform technical document classification, filing, deleting and importing/exporting or any combination of the above functions, as shown in step 1420.

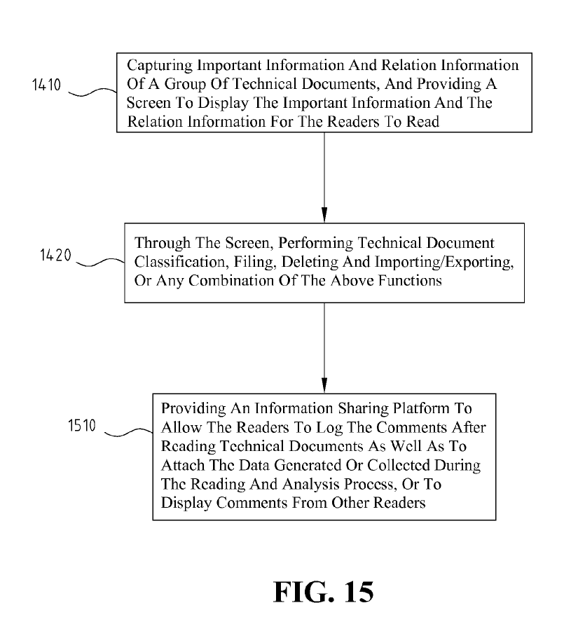

Following step 1420, the present invention may further include a step of providing an information sharing platform. The information sharing platform allows the readers to log the comments after reading technical documents as well as to attach the data generated or collected during the reading and analysis process, or to display comments from other readers, as shown in step 1510 of FIG. 15. Accordingly, the present invention also provides a reading and commentating method for technical documents.

Therefore, the present invention provides a system platform for technical documents to form a technical document network so as to effectively accumulate and share the team knowledge, and accomplish search and analysis for technical documents in a fast and effective manner. In addition, because the present invention translates patent documents into different states, the present invention can greatly reduce the system load caused by repetitive or many users trying to open graphic format files simultaneously.

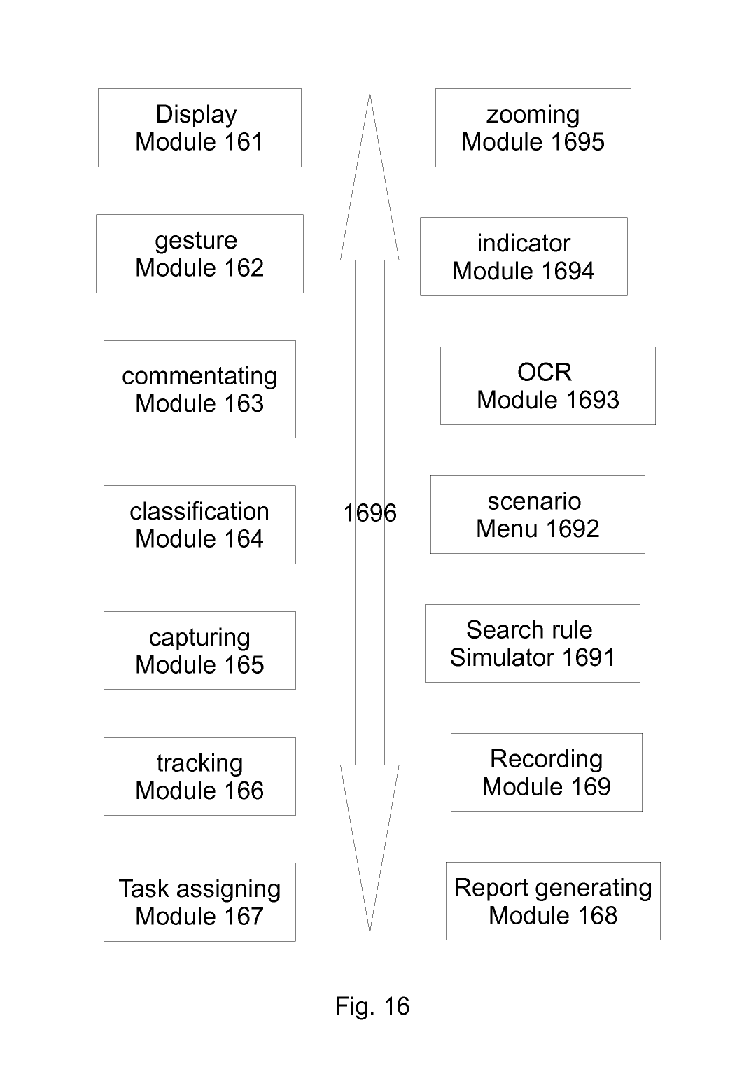

Please refer to FIG. 16, which illustrates another embodiment according to the present invention. In FIG. 16, a system for managing patent documents is disclosed. The system may be implemented with computer codes stored in a non-transient computer readable medium and these computer codes are executable by a processor in a computer or any electronic devices. The system has a display module 161, a gesture module 162, a commentating module 163, a classification module 164, a capturing module 165, a tracking module 166, a task assigning module 167, a zooming module 1695, a indicator module 1694, an OCR module 1693, a scenario menu 1692, a search rule simulator 1691, a recording module 169 and a reporting generating module 168. Please be noted that although the system illustrated in FIG. 16 has many modules, in different design needs, one or more modules may be removed. Meanwhile, other modules not illustrated here may also be added to the system. These modules may be coded with software codes running on a machine, and may be coded with software codes running on multiple machines together providing the functions as explained below. These modules communicate to each via an interface 1696, which may be, but not limited to, a framework, a virtual machine, an operating system, etc. In the following description, these modules are explained one after another.

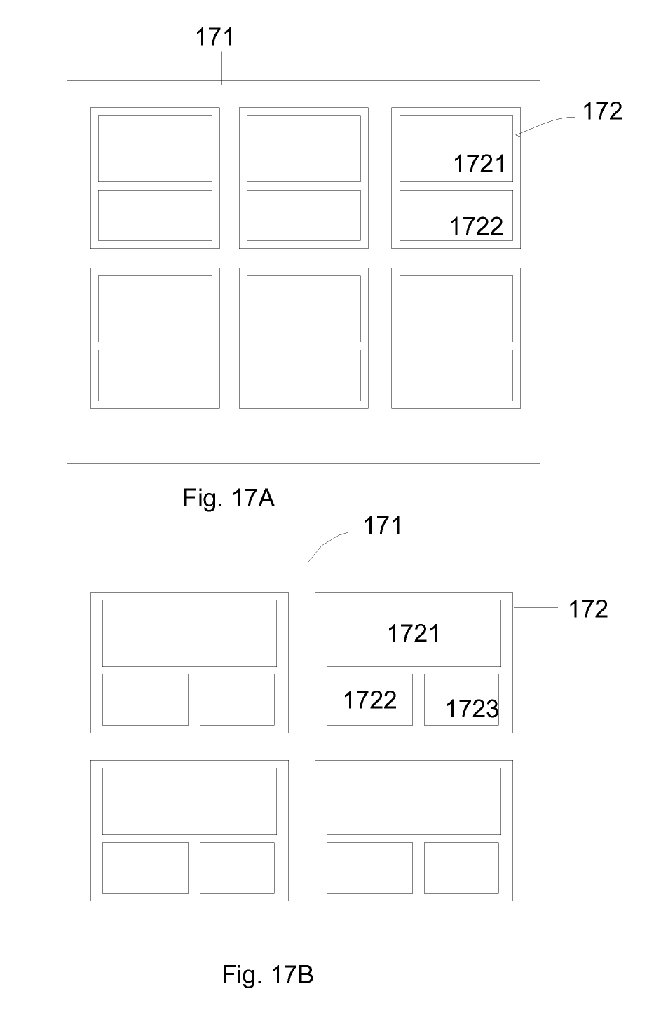

Please refer to FIG. 17A to FIG. 17D, which illustrate a plurality of patent documents shown in document units 172 in different display ratios appeared in a screen area 171. A zooming module (not shown) co-works with a display module for showing the content illustrated in FIG. 17A to FIG. 17D. According to instruction of a user, the zooming module zooms or and zooms out the showing of the plurality of patent documents at different display ratios for the document units. In different ratios, in addition that drawings or fonts may be displayed with different size, different amount of information may be displayed for different display ratios instructed by a user.

For example, in FIG. 17A, two blocks 1721, 1722 of information are displayed in a document unit. The block 1721 may be a drawing or part of a drawing, e.g. the related information as mentioned above. The block 1722 may be important information, like combination of text of filing dates, application numbers, assignees, inventors, etc. FIG. 17B shows a display in a bigger display ratio, i.e. each document unit occupies a bigger area, even the screen area 171 remains the same. In FIG. 17B, in addition to the blocks 1721 and 1722, another block 1723 of information is displayed in a document unit 172. For example, a portion or even all text of abstract of a patent document is displayed in the block 1723. Please be noted that the blocks 1721, 1722 and 1723 may contain different information under different designs, not limited to the examples described here.

FIG. 17C and FIG. 17D respectively illustrate displaying the patent documents in a larger display ratio and in a smaller display ratio. In FIG. 17C, additional block 1725 of information, e.g. comments by other users, may be displayed in a document unit 172, in addition to another four blocks 1721, 1722, 1723, 1724 of information. In contrast, in FIG. 17D, each document unit 172 may show only one block 1721 of information. Please be noted that even one block of information is shown in a document unit, multiple pieces of information may be combined to appear in a block in a document unit. For example, a title, a portion of text from the abstract or claims. On the other hand, a minimized drawing or a portion of a drawing may be displayed in a block in a document unit.

The instruction for instructing the zooming module to zoom in or to zoom out may be implemented by a gesture module. The gesture module converts one or more than one touch gestures on a touch panel into a corresponding zoom instruction. For example, while pressing and moving out with two fingers on a touch panel, the gesture module translates such touch gesture as a zoom in, to show the document unit with larger display ratio. Touch panels now can be found in tablet computers like iPad and laptop computers installed with Windows 8. For brevity, no lengthy description on how to implementing the gesture module is further explained here.

Alternatively, the zoom instructed may be obtained via an indicator module. The indicator module translates an indicator device operation into a zoom instruction. For example, the indicator device may be a mouse device. When a user presses a scrolling wheel or dragging a zooming control on a display, such operation is translated as a corresponding zoom instruction indicating how the display module to display the plurality of patent documents.

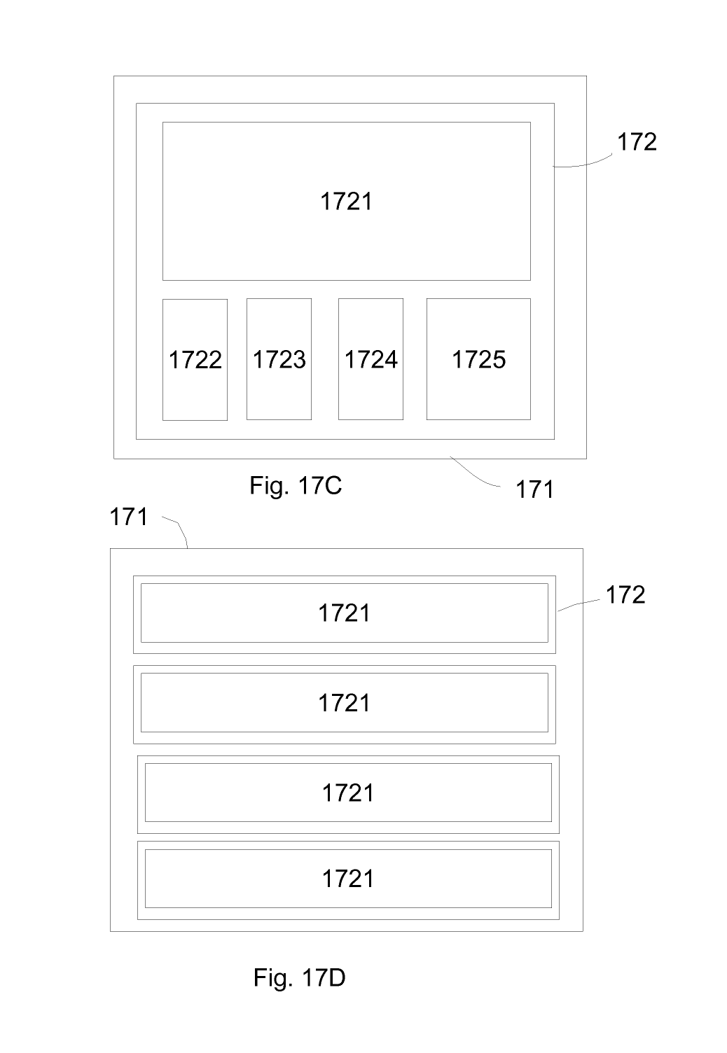

In addition to perform zoom-in or zoom-out operation, the gesture module and/or the indicator module may be used for receiving operation of a user for dragging one or more than one patent documents to a class under a classification. FIG. 18 illustrates such operation. Two selected document units corresponding to two patent documents are dragged and dropped on a class 183 which refers to a class or a sub-class under a classification rule, like the class 184 and 185. The document units, after being dragged and dropped to a class, may be replaced with other document units or removed from the screen area. In other words, under such mode, a user may easily classify all patent documents into associated classes. Alternatively, in another mode, a patent document may be classified into multiple classes. For example, a patent document may be classified into “helpful”, “to-be-studied-in-more-detailed” and “LED module” classes. The first class “helpful” indicates a score or value of the patent document under certain analysis, e.g. to find prior art for invalidating a patent at issue. Other parallel options like “unrelated” may be listed aside the class as a graphical icon. The second class “to-be-studied-in-more-detailed” may be filtered along with other patent documents in the class to be studied later. The third class “LED module” indicates that the patent document classified in the class is related to LED module technology. Please be noted that many other variations on how to define and uses classes may be derived under different needs and the examples here are not used for limiting the scope of the invention.

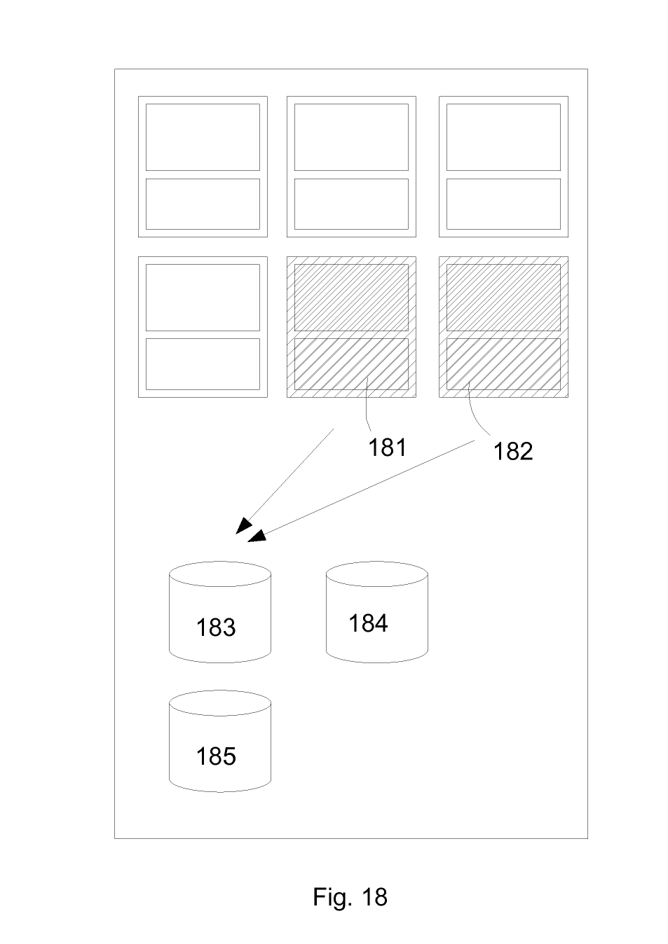

In FIG. 19, a commentating module is used for a user or multiple users in the system to comment on patent documents they are reading. For example, a document unit 192 is selected and a pop-up window 191 is shown for a user to enter comments related to the patent document associated to the selected document unit 192. There are various ways to design the comment interface. For example, a selection from multiple options 1911 may be provided and/or a text area may be provided for users to enter a title, one or more than one text paragraph formatted in pure text format or in rich form containing images and attached documents, e.g. an URL to a web page, a PDF document, an image file, etc.

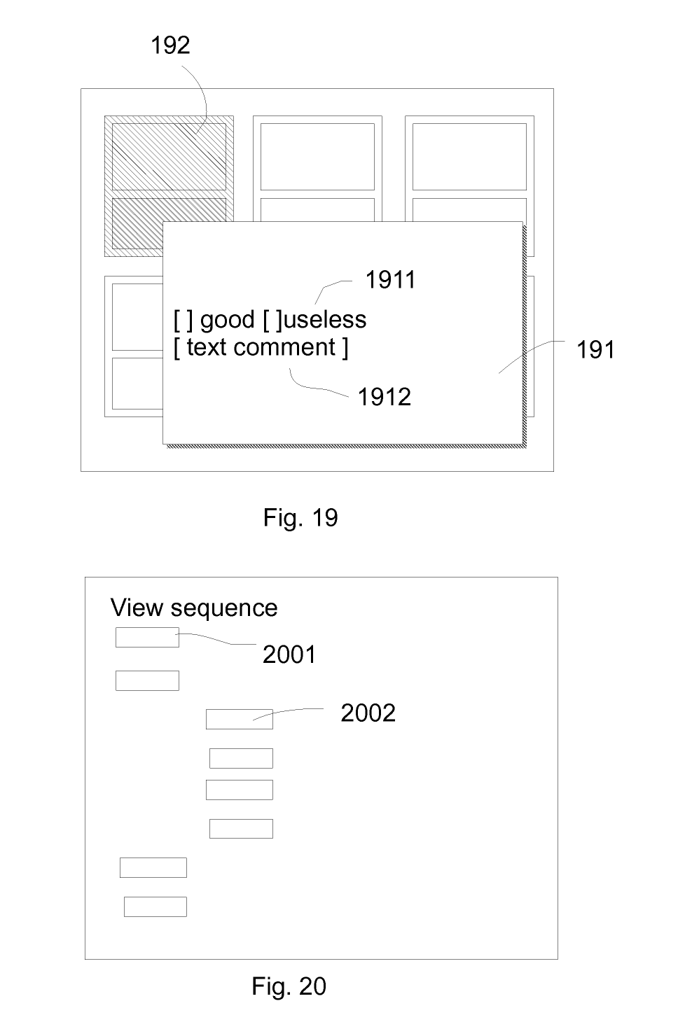

When there are many patent documents to be handled by one or more than one users via the system, a tracking module is provided for tracking viewing sequences of users to view, analyze and/or comment the patent documents. Usually, after a users reads one patent document, the user may be inspired, under clues of the patent document, to search for even more patent documents. Thus, a capturing module is provided for capturing more patent documents to be viewed, analyzed and commented. The tracking module may be designed to record not only the sequence the user views the patent documents, e.g. patent document X1, then patent document X2, then patent document X3, etc., but also to record how certain patent documents appear during the analysis, e.g. searching and capturing new patent documents when reading certain patent document. Such trace may be rendered as a tree graph, a list or a network with links to the patent documents and is helpful to keep the user not lost during studying vast patent documents. For example, FIG. 20 illustrate a trace example how a user conducts analysis for multiple patent documents. The patent documents 2001 aligned left is found under a first search rule. The patent documents 2002 are found when the user reads the second patent document. Search rule may be recorded and the hierarchy shows how the search is found under a logic tree structure.

When multiple users are in a project for together analyzing certain patent documents, a task assigning module is designed for dispatching tasks, e.g. different sets of patent documents captured by a capturing module or different search rules to multiple users. The task assigning module may be designed to collect performing information dynamically and showing such information to a project manager to control progress of an analysis task. An authorizing module may be designed for controlling access levels for a group of users. As mentioned above, a commentating module may be provided for users in a team to share comments corresponding to different patent documents.

Usually, a report is needed after an analysis task is performed. The system may also include a report generating module for generating a report, e.g. by incorporating who and when the analysis is conducted, patent documents under which search rules are captured and viewed, useful information gathered from the commentating module, etc. With such function, a lot of effort is saved for increasing higher performance.

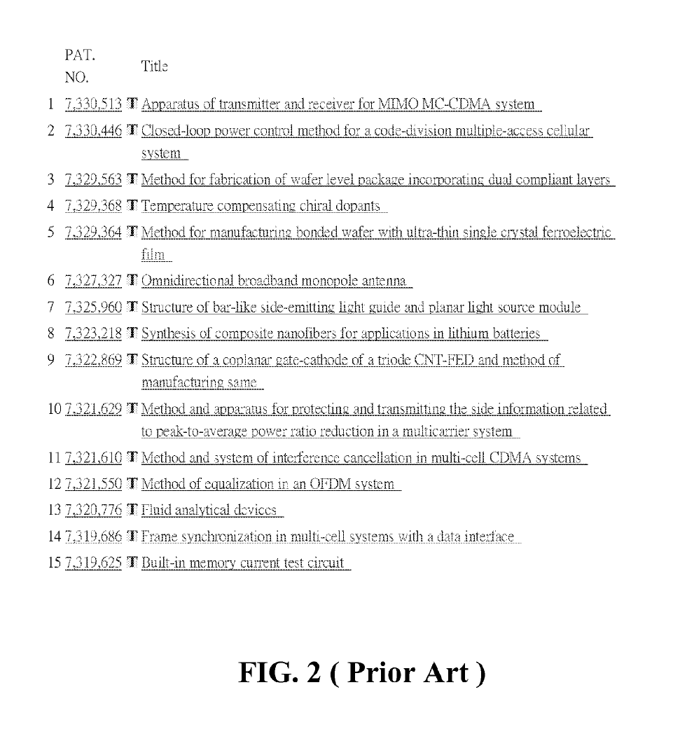

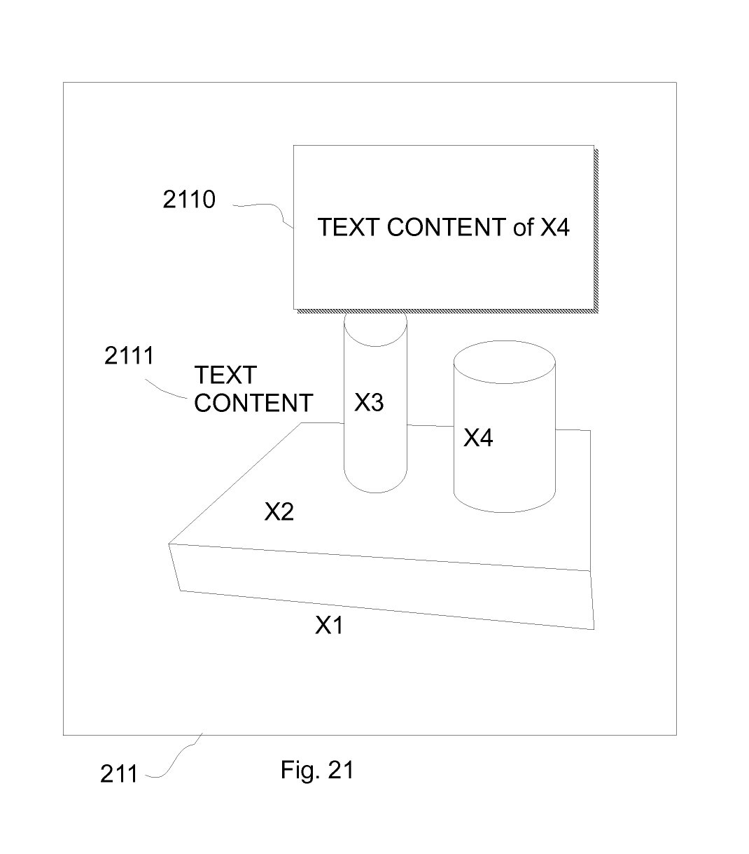

In addition, current patent databases usually provide drawings in image format and, in addition, even text description in text format. FIG. 21 illustrates how an OCR module is used for associating text content of a specification from a patent database to a drawing. In the screen area 211, a drawing illustrates a structure with elements X1, X2, X3 and X4. Under OCR processing, numerals like “511”, “40”, “FIG. 2” are extracted from the image file of the drawing. These numerals are used for finding associated text content in a specification also captured from a patent database. The text content 2111 may be directly attached aside associated numerals in a drawing. Alternatively, a pop-up window may appear to show corresponding text content 2110. All these text contents 111, along with their origins, e.g. “col. 7, lines 14-15”, may be copied and pasted to a report maintained by a commentating module and a report that is generated by a report generating module as mentioned above may incorporate such information to make the report more readable.

Because under different analysis work, different needs and different types of tasks need to be applied. The system may provide a scenario menu for a user or a team to select before conducting following analysis. For example, prior art searching for invalidating a patent at issue has quite different characteristic from patent map creation. Different scenarios are decided and different appearance, e.g. how a report is generated, how document units, including what type of information should be shown in block within a document unit, are shown, what comment fields should be included, etc. are generated and provided to users with different interfaces, upon different combination of modules mentioned above.

Besides, a search simulator may be provided for previewing information of patent documents under different search rules. With such design, users may check whether a search rule is proper, e.g. bringing too many patent documents, before patent documents are really captured and rendered to speed up analysis and increases efficiency of work.

Although in the above example, patent documents are used for example, but please be noted that other types of documents, like technical documents, commercial documents or other types of documents may be used under same or similar system logic and should be considered within the scope of the invention, too.

Besides, patent documents are used for explaining embodiments of the present invention, but other type of equivalent document types may also be used in such system. For example, the system may be used for capturing trademark documents from trademark databases. Sometime, trademark documents contain drawings like logos or identifiers for distinguishing the products from others and such drawings may be regarded as related information as mentioned above. Another example is medicine database, which contains many medicine products, with drawings and corresponding description like name of the medicine, side effects, etc. Such documents, not limited to those described here, may also be used in such system to gain helpful effect. As being illustrated and explained above, in addition to the equivalent application on patent documents, trademark, trade dress documents or other intellectual property related documents may also be regarded falling within equivalent scope under interpretation, which uses same or similar ways and functions to achieve same or similar result.

The above exemplary disclosed embodiments of the present invention may be implemented with computer readable instructions. These computer readable instructions may be stored in a non-transient computer readable medium containing and these computer readable instructions may be executed by one or more processors. Nevertheless, please be noted that along with technology advance, these computer readable instructions may be written for various electronic devices and may be partly embodied as hardware circuit while other part being implemented as software or firmware. Other variation of implementations should also regarded within the scope of the invention.

Although the present invention has been described with reference to the exemplary embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A system for managing technical documents, said system at least comprising a graphical screen divided into a plurality of document units arranged in a m×n manner, where both m and n are integers larger than 1, each of said document units being a screen area for displaying document information of a document, and said document information including important information, at least one related drawing or both of the document.

2. The system of claim 1, wherein the documents are patent documents and the system comprising:
a display module for showing a plurality of patent documents, each patent document being displayed in the document unit of the screen area; and
a zooming module for zooming in or zooming out the showing of the plurality of patent documents at different display ratios for the document units, wherein the document unit shows more information of the patent document in a first display ratio than information of the patent document in a second display ratio, where the first display ratio is larger than the second ratio.

3. The system of claim 2, further comprising a gesture module for translating a first touch gesture into a zoom instruction for indicating the zooming module to zoom in or to zoom out.

4. The system of claim 3, further comprising a classification module, wherein the gesture module translates a second touch gesture into a drag-and-drop instruction for indicating at least one patent document shown in the document unit being dragged to a class to perform classification of the plurality of patent documents.

5. The system of claim 2, further comprising an indicator module for translating an indicator device operation into a zoom instruction for indicating the zooming module to zoom in or to zoom out.

6. The system of claim 5, further comprising a classification module, wherein the indicator module translates a second indicator operation into a drag-and-drop instruction for indicating at least one patent document shown in the document unit being dragged to a class to perform classification of the plurality of patent documents.

7. The system of claim 2, further comprising a commentating module, wherein the commentating module provides an interface for a user to record comment for the patent document viewed in the document unit.

8. The system of claim 7, further comprising a capturing module for capturing more patent documents with a search rule to be analyzed.

9. The system of claim 7, further comprising a tracking module for tracking a viewing sequence indicating an order the user views and captures the plurality of patent documents.

10. The system of claim 2, further comprising a task assigning module for assigning viewing tasks among a plurality of team users.

11. The system of claim 10, further comprising a capturing module for capturing more patent documents with a search rule by at least one of the team users, wherein the newly captured patent documents are assigned to the team users via the task assigning module.

12. The system of claim 11, further comprising a recording module for recording a list of the patent documents viewed and captured by the team users, the list showing at least one search rule for capturing the patent documents.

13. The system of claim 12, further comprising a commentating module for the team users to comment on the patent documents and a report generating module for automatically generating a report containing the list of the patent documents and comments made by the team users for the patent documents.

14. The system of claim 2, further comprising an optical character recognition (OCR) processing module for performing OCR on at least one drawing of the patent document and maps numerals in the drawing to associated text content of a specification of the patent document.

15. The system of claim 14, further comprising superimposing the text content into the drawing.

16. The system of claim 15, wherein the text context is shown in a pop-up window when the numeral is selected.

17. The system of claim 2, further comprising a scenario menu for a user to select a scenario for analyzing the patent documents and provides different interfaces to conduct different analysis, the scenario to be selected comprising prior art searching for patentability of a patent and patent map creation.

18. The system of claim 2, further comprising a search rule simulator for previewing information of the patent documents under different search rules.

19. A reading system for documents, said reading system at least comprising a graphical screen divided into a plurality of document units arranged in a m×n manner, where both m and n are integers larger than 1, each of said document units being a screen area for displaying document information of a document, and said document information including important information, at least one related drawing or both of the document.

20. A system for managing intellectual property documents, said system at least comprising a graphical screen divided into a plurality of document units arranged in a m×n manner, where both m and n are integers larger than 1, each of said document units being a screen area for displaying at least one related drawing related to an intellectual property document.
